(19) United States
(12) Patent Application Publication
(10) Pub. No.: US 2016/0260381 A1
(43) Pub. Date: Sep. 8, 2016

(54) ARRAY SUBSTRATE, DRIVING METHOD THEREOF AND DISPLAY DEVICE

(71) Applicant: BOE TECHNOLOGY GROUP CO., LTD., Beijing (CN)

(72) Inventors: Cuili GAI, Beijing (CN); Zhongyuan WU, Beijing (CN); Rui XU, Beijing (CN)

(73) Assignee: BOE TECHNOLOGY GROUP CO., LTD., Beijing (CN)

(21) Appl. No.: 14/787,392

(22) PCT Filed: Mar. 13, 2015
(86) PCT No.: PCT/CN2015/074179

§ 371 Date: Oct. 27, 2015

(30) Foreign Application Priority Data
Oct. 30, 2014 (CN) 201410597271.X

(51) Int. Cl. G09G 3/3258; G09G 3/3266

(52) U.S. Cl. CPC G09G 3/3258; G09G 3/3266; G09G 2330/028; G09G 2320/0233; G09G 2300/043; G09G 2310/0289; G09G 2320/0223; G09G 2320/0626

(57) ABSTRACT

Disclosed are an array substrate, a driving method thereof, and a display device. The array substrate comprises a scan driving unit (10) located in a peripheral area and configured to input an enable signal to one terminal of at least one driving control line (Vdd) in a display area so as to drive an OLED device to emit light. The array substrate further comprises at least one compensation control unit (100) and a compensation voltage source (101) configured to provide a compensation voltage (Vc). One terminal of the compensation control unit (100) is connected to the compensation voltage source (101), the other terminal thereof is connected to the other terminal of the at least one driving control line (Vdd), and the compensation control unit (100) is configured to control the compensation voltage source (101) to input the compensation voltage (Vc) to the other terminal of the driving control line (Vdd). The compensation voltage (Vc) is less than or equal to a voltage (VDD) of the enable signal, mura caused by IR Drop can be eliminated.

### TECHNICAL FIELD

The present disclosure relates to an array substrate, a driving method thereof and a display device.

### BACKGROUND

With the rapid advances in display technology, semiconductor element technology, as the core of display devices, also achieves leaps of progress. For known display devices, OLED (Organic Light Emitting Diode), as a current-type light emitting device, is increasingly applied in the field of high-performance display because its characteristics such as self-illumination, fast response, wide viewing angle, and capable of being fabricated on a flexible substrate and so on. According to different driving manners, OLED may be divided into two categories, the PMOLED (Passive Matrix Driving OLED) and the AMOLED (Active Matrix Driving OLED). Since an AMOLED display has advantages such as low manufacturing cost, high response speed, power saving, DC driving applicable to portable devices, large operating temperature range and so on, it has a prospect of replacing LCD (liquid crystal display) to become a next generation new-type flat panel display.

### SUMMARY

At least one embodiment of the present disclosure provides an array substrate and a driving method thereof, and a display device, which can eliminate the mura phenomenon caused by IR drop.

According to a one aspect of the at least one embodiment of the present disclosure, there is provided an array substrate, comprising: a scan driving unit located in a peripheral area and configured to input an enable signal to one terminal of at least one driving control line in a display area; and further, at least one compensation control unit and a compensation voltage source configured to provide a compensation voltage; wherein one terminal of the compensation control unit is connected to the compensation voltage source, the other terminal thereof is connected to the other terminal of the at least one driving control line, and the compensation control unit is configured to control the compensation voltage source to input the compensation voltage to the other terminal of the driving control line; wherein the compensation voltage is less than or equal to a voltage of the enable signal.

According to another aspect of the at least one embodiment of the present disclosure, there is provided a display device, comprising the array substrate as described above.

According to yet another aspect of the at least one embodiment of the present disclosure, there is provided a driving method for an array substrate, comprising: inputting, by a scan driving unit, an enable signal to one terminal of at least one driving control line in a display area; controlling, by a compensation control unit, a compensation voltage source to input a compensation voltage to the other terminal of the driving control line; wherein the compensation voltage is less than or equal to a voltage of the enable signal.

At least one embodiment of the present disclosure provides an array substrate and a driving method thereof, and a display device. The array substrate comprises a scan driving unit located in a peripheral area and configured to input an enable signal to one terminal of at least one driving control line in a display area so as to drive an OLED device to emit light. In addition, the array substrate further comprises at least one compensation control unit and a compensation voltage source configured to provide a compensation voltage; one terminal of the compensation control unit is connected to the compensation voltage source, the other terminal thereof is connected to the other terminal of the at least one driving control line, and the compensation control unit is configured to control the compensation voltage source to input the compensation voltage to the other terminal of the driving control line. As such, when the scan driving unit inputs the enable signal to one terminal of the driving control line, the OLED device of the AMOLED display emits light. In this case, the compensation control unit can control the compensation voltage source to input the compensation voltage to the other terminal of the driving control line, thus compensating for the enable signal received by a pixel unit that is away from the scan driving unit. Since the compensation voltage is less than or equal to a voltage of the enable signal, the mura caused by a constant decrease of the voltage of the enable signal during transmission (i.e., IR Drop) can be avoided. Thereby, the quality of a displayed picture and quality of the display can be improved.

### BRIEF DESCRIPTION OF THE DRAWINGS

FIG. 1 is a schematic diagram of a structure of an array substrate provided by a known technical solution;

FIG. 2a is a schematic diagram of a structure of an array substrate provided by an embodiment of the present disclosure;

FIG. 2b is a schematic diagram of a structure of another array substrate provided by an embodiment of the present disclosure;

FIG. 3 is a schematic diagram of a partial structure of a pixel circuit provided by a known technical solution;

FIG. 4 is a schematic diagram of a structure of another array substrate provided by an embodiment of the present disclosure;

FIG. 5a is a schematic diagram of a structure of yet another array substrate provided by an embodiment of the present disclosure;

FIG. 5b is a schematic diagram of a structure of again yet another array substrate provided by an embodiment of the present disclosure; and

FIG. 6 is a flowchart of a driving method for an array substrate provided by an embodiment of the present disclosure.

### DETAILED DESCRIPTION OF THE EMBODIMENTS

Hereinafter, the technical solutions in the embodiments of the present disclosure will be described clearly and completely in combination with the drawings in the embodiments of the present disclosure. Obviously, these described embodiments are parts of rather than all of the embodiments of the present disclosure. All the other embodiments obtained by those skilled in the art based on the embodiments of the present disclosure without paying creative efforts fall into the protection scope of the present disclosure.

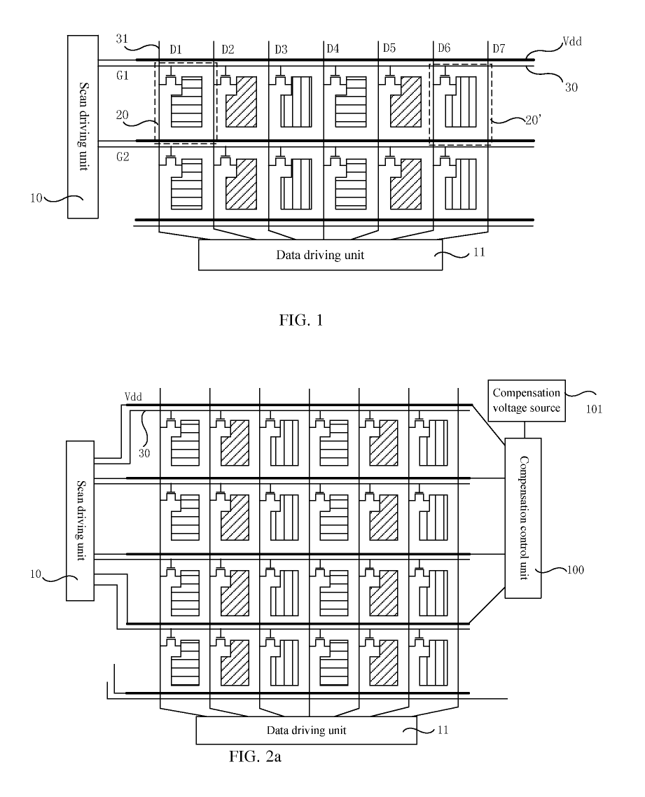

FIG. 1 is a schematic diagram of a structure of an array substrate provided by a known technical solution. In the known technical solution, for a large-size AMOLED display, since a backplane power line has certain resistance, when the OLED device emits light, a driving current for all pixels is supplied by a scan driving unit 10 as shown in FIG. 1 to each pixel unit 20 through a driving control line Vdd. Thus, in the aforesaid light emitting phase, a voltage inputted to a pixel unit 20 located close to the scan driving unit 10 is higher than a voltage inputted to a pixel unit (for instance, pixel unit 20′ in the last column) located farther away from the scan driving unit 10. This phenomenon is called internal resistance drop (IR Drop).

Because the voltage inputted by the scan driving unit 10 to the pixel unit 20 (or the pixel unit 20′) is associated with a current flowing through each pixel unit, IR Drop may lead to a difference of the currents flowing through the pixel units 20 at different positions, which causes the AMOLED display to generate luminance difference at the time of displaying. For instance, when pixels in the first row are all lightened, luminance displayed by them will be dimmed gradually from left to right. The aforesaid phenomenon of luminance difference is called a mura phenomenon. This will lead to quality decrease of the displayed picture, thereby causing a negative impact on the quality of the display and the display effect.

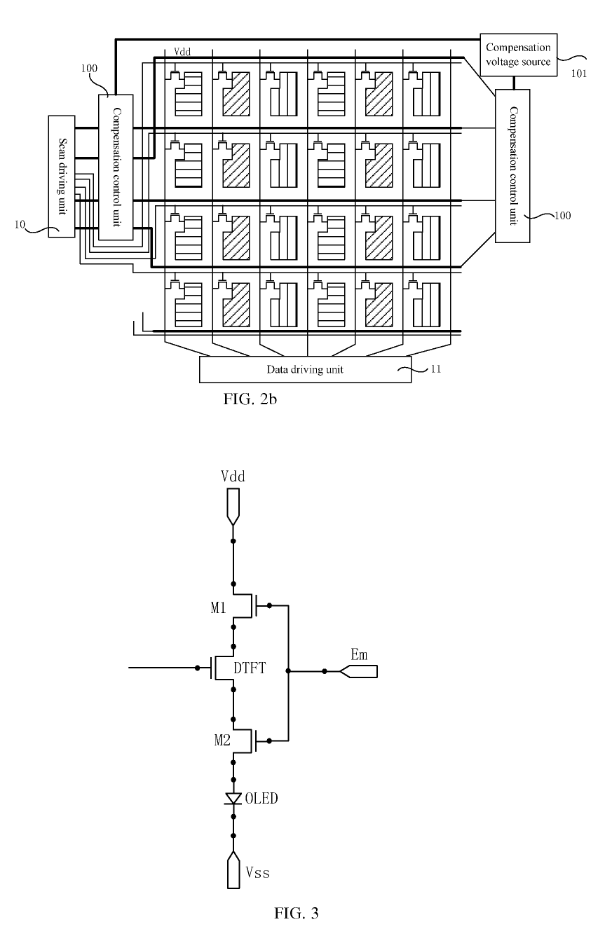

FIG. 2a is a schematic diagram of a structure of an array substrate provided by an embodiment of the present disclosure. As shown in FIG. 2a, the array substrate may comprise a scan driving unit 10 located in a peripheral area. The scan driving unit 10 is configured to input an enable signal to one terminal of at least one driving control line Vdd in a display area, so as to drive the OLED device to emit light. The magnitude of the enable signal is VDD. In addition, the array substrate may further comprise at least one compensation control unit 100 and a compensation voltage source 101 configured to provide a compensation voltage Vc.

One terminal of the compensation control unit 100 is connected to the compensation voltage source 101, the other terminal thereof is connected to the other terminal of the at least one driving control line Vdd; and the compensation control unit 100 is configured to control the compensation voltage source 101 to input the compensation voltage Vc to the other terminal of the driving control line Vdd;

The compensation voltage Vc mentioned above is less than or equal to a voltage (VDD) of the enable signal.

The embodiment of the present disclosure provides an array substrate, comprising a scan driving unit located in a peripheral area and configured to input an enable signal to one terminal of at least one driving control line in a display area, so as to drive the OLED device to emit light. In addition, the array substrate further comprises at least one compensation control unit and a compensation voltage source configured to provide a compensation voltage; one terminal of the compensation control unit is connected to the compensation voltage source, the other terminal thereof is connected to the other terminal of the at least one driving control line, and the compensation control unit is configured to control the compensation voltage source to input the compensation voltage to the other terminal of the driving control line. As such, when the scan driving unit inputs the enable signal to one terminal of the driving control line, the OLED device of the AMOLED display emits light. In this case, the compensation control unit can control the compensation voltage source to input the compensation voltage to the other terminal of the driving control line, thus compensating for the enable signal received by a pixel unit that is away from the scan driving unit. Since the compensation voltage is less than or equal to a voltage of the enable signal, the mura caused by a constant decrease of the voltage of the enable signal during transmission (i.e., IR Drop) can be avoided. Thereby, quality of displayed pictures and quality of the display can be improved.

It should be noted that, firstly, the display area mentioned above refers generally to an Active Area (referred to as AA area in short), inner of this display area is as shown in FIG. 1, multiple gate lines 30 and multiple data lines 31 intersecting vertically and horizontally are provided. Intersecting of the gate lines 30 and the data lines 31 defines multiple pixel units 20 arranged in a matrix form.

The peripheral area mentioned above refers to area other than the AA area on the array substrate. The peripheral area includes a binding area and a wiring area. The scan driving unit 10 and a data driving unit 11 are provided in the binding area, scanning signals (G1, G2 . . . Gn) for turning on TFTs (Thin Film Transistors) are inputted to the gate lines 30, data signals (D1, D2 . . . Gm) for displaying pictures are inputted to the data lines 31, respectively, through signal leads in the wiring area.

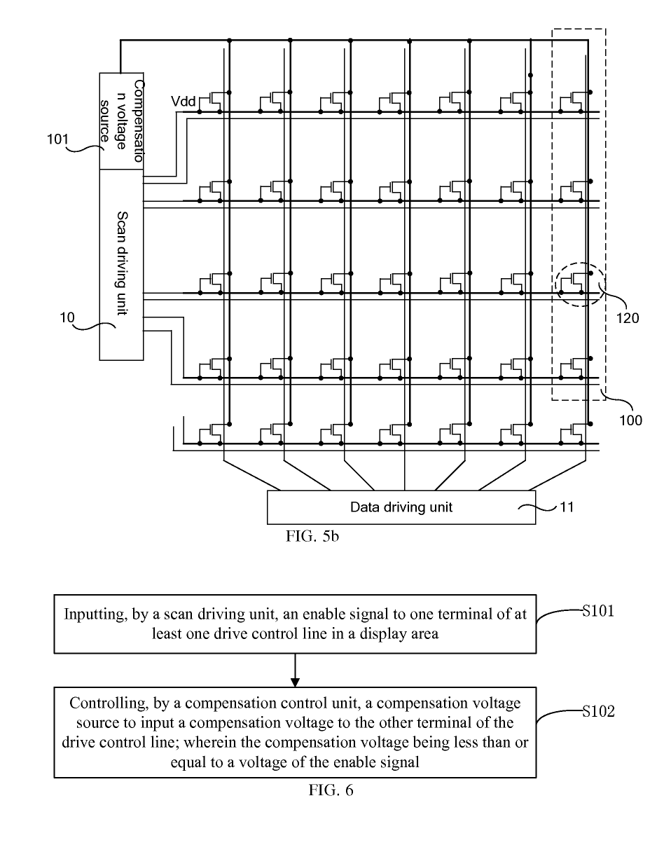

Secondly, one terminal of the driving control line Vdd refers to one terminal by which the driving control line Vdd and the scan driving unit 10 contact on the array substrate; and the other terminal of the driving control line Vdd refers to one terminal by which the driving control line Vdd and the compensation control unit 100 contact, except the terminal by which the driving control line Vdd and the scan driving unit 10 contact. Thus, the compensation control unit 100 connected to the other terminal of the driving control line Vdd may be located in a portion which is away from the scan driving unit 10 in the peripheral area, as shown in FIG. 2a; or located in the display area, as shown in FIG. 5b. It may also be located in a portion which is close to the scan driving unit 10 in the peripheral area (not shown); or, in order to enhance compensation effect, the compensation control unit 100 mentioned above may be, as shown in FIG. 2b, provided in both the portion that is close to the scan driving unit 10 and the portion that is away from the scan driving unit 10 in the peripheral area. The compensating control unit 100 mentioned above may also be provided in both the display area and the peripheral area. The present disclosure makes no limitation thereto.

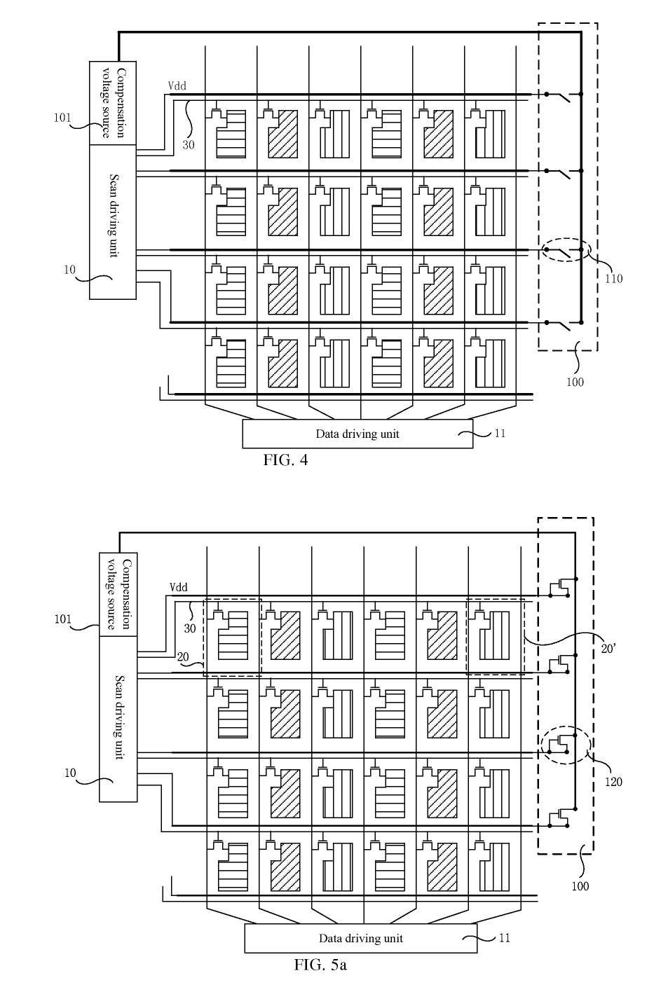

Thirdly, in order to make the wiring area and the binding area of the peripheral area compact structurally, the compensation voltage source 101 may be, as shown in FIG. 4, provided in the scan driving unit 10. Thereby, it is possible to save space in the peripheral area.

Fourthly, in order to improve carrier mobility of the TFT in the AMOLED display and reduce resistivity, so that the power consumption is small when the same current flows, polysilicon is usually adopted to compose the aforesaid TFT. However, due to production process and prosperities of polysilicon, when manufacturing a TFT switch circuit on a glass substrate with a large area, electrical parameters such as threshold voltage Vth, mobility and so on often fluctuate, so that the current flowing through the OLED device not only varies with change of a conduction voltage stress due to long-time turning-on of the TFT, further, it also varies with drifting of the threshold voltage Vth of the TFT. As such, it will affect uniformity and constancy of the luminance of the display.

To solve the above problem, typically, the design of a threshold voltage compensation circuit in a pixel circuit is adopted to compensate for the threshold voltage Vth of the TFT, thereby reducing affect caused by the threshold voltage on uniformity of the display luminance. For instance, in the process of compensating for the threshold voltage Vth, a sum of a data voltage Vdata and the threshold voltage Vth (i.e., Vdata+Vth) will be written to a gate of a drivomg transistor DTFT. FIG. 3 is a schematic diagram of a partial structure of a pixel circuit provided by a known technical solution. In a light emitting phase, a light emitting control line Em turns on transistors M1 and M2, the scan driving unit 10 will input an enable signal to one terminal of the driving control line Vdd to drive the OLED device to emit light. Because in this case a gate-source voltage Vgs of the driving transistor DTFT is approximately Vdata+Vth−VDD, as a result, a driving current I flowing through the OLED device can be obtained as I=K/2(Vdata+Vth−VDD−Vth)²=K/2(Vdata−VDD)², where K is a gain factor of the transistor. Accordingly, the driving current of the driving transistor DTFT is independent of the threshold voltage Vth, and will not be affected by the threshold voltage Vth.

During operation of the pixel circuit mentioned above, it is possible to input an enable signal to the driving control line Vdd only in the light emitting phase (voltage of the enable signal is at a high voltage level), and input a low voltage level to the driving control line Vdd in the other phases, such as the compensation phase mentioned above. As a result, the compensation control unit 100 only needs to control the compensation voltage source 101 to input the compensation voltage Vc to the other terminal of the driving control line Vdd when the driving control line Vdd receives the enable signal.

FIG. 4 is a schematic diagram of a structure of another array substrate provided by an embodiment of the present disclosure. In order to control an output of the compensation voltage source 101, as shown in FIG. 4, the compensation control unit 100 may include at least one control switch 110.

One terminal of the control switch 110 is connected to the compensation voltage source 101, the other terminal thereof is connected to the other terminal of the driving control line Vdd. As such, the control switch 110 can be turned on when the driving control line Vdd receives the enable signal, so that the compensation voltage source 110 and the other terminal of the driving control line Vdd are connected, the compensation voltage is inputted to the other terminal of the driving control line, thus compensating for the enable signal received by the pixel unit away from the scan driving unit, to avoid mura caused by a constant decrease of the voltage of the enable signal during transmission (i.e., IR Drop).

Fifthly, when the voltage of the enable signal inputted by the scan driving unit 10 to one terminal of the driving control line Vdd is always at a high voltage level (i.e., a DC signal) (for instance, in a array substrate in which the pixel circuit is not provided with a compensation loop), the compensation control unit 100 on the array substrate may be a metal wire that connects the compensation voltage source 101 and the other terminal of the driving control line Vdd.

Further, in order to control the compensation voltage source 101 to be capable of automatically inputting the compensation voltage Vc to the other terminal of the driving control line Vdd when the driving control line Vdd receives the enable signal, as shown in FIG. 5a or 5b (FIGS. 5a and 5b are schematic diagrams of structures of another two array substrates provided by an embodiment of the present disclosure), the control switch 110 may include a thin film transistor 120.

A gate and a first electrode of each thin film transistor 120 are connected to the other terminal of the driving control line Vdd, and a second electrode thereof is connected to the compensation voltage source 101. As such, when the driving control line Vdd receives the enable signal, the enable signal is inputted to the gate of the thin film transistor 120 to turn on the thin film transistor 120. The compensation voltage Vc inputted by the compensation voltage source 101 is inputted to the other terminal of the driving control line Vdd through the thin film transistor 120, thus compensating for the enable signal received by the pixel unit away from the scan driving unit, to avoid mura caused by a constant decrease of the voltage of the enable signal during transmission (i.e., IR Drop).

It should be noted that in the embodiments of the present disclosure, description is provided by taking an example that the first electrode of the thin film transistor 120 may be a source, the second electrode thereof may be a drain.

Hereinafter, structure of the array substrate will be described in detail in a case where the control switch 110 is a thin film transistor 120.

### First Embodiment

As shown in FIG. 5a, in a case where the compensation control unit 100 is in the peripheral area, a gate and a first electrode of the thin film transistor 120 is connected to one terminal of the driving control line Vdd that is away from the scan driving unit 10. In this case, a second electrode of the thin film transistor of 120 is still connected to the compensation voltage source 101. As such, in the light emitting phase, the compensation voltage Vc inputted by the compensation voltage source 101 can be inputted from the last column of pixel unit 20′ through the compensation control unit 100, thus compensating for the enable signal received by the pixel unit 20′. A phenomenon that the enable signal received by the pixel unit 20′ located away from the scan driving unit 10 has been reduced, which is caused by IR Drop due to a too large display screen and too many load resistors, can be avoided. Accordingly, the above solution can reduce luminance difference between pixels, and avoid the generation of mura.

### Second Embodiment

As shown in FIG. 5b (structures like TFT and pixel electrodes in the pixel unit are omitted), in a case where the compensation control unit 100 is located in the display area (AA area), one thin film transistor 120 is provided in one pixel unit 20 in the display area. A gate and a first electrode of the thin film transistor are connected to the driving control line Vdd, a second electrode thereof is connected to the compensation voltage source 101.

In comparison to the First Embodiment, it can be known that, in the Second Embodiment, not only in the light emitting phase the compensation voltage Vc inputted by the compensation voltage source 101 can be inputted from the last column of pixel unit 20′ through the compensation control unit 100, thus compensating for the enable signal received by the pixel unit 20′, moreover, it is also possible to compensate for the pixel unit 20 at an arbitrary position where the thin film transistor 20 is provided, so as to avoid mura. The Second Embodiment achieves better effects with regard to eliminating mura than the First Embodiment, but the thin film transistor 120 is located in the display area, thus an aperture ratio of the display panel will be affected. Therefore, one skilled in the art can select a position where the compensation control unit 100 is provided as needed in practice.

In addition, FIG. 5b provides illustration with each column of pixel unit 20 being provided with the compensation control unit 100, and each pixel unit 20 corresponding to one thin film transistor 120 as an example. In order to improve the aperture ratio, the compensation control unit 100 may also be provided only in part of the columns, for instance, one compensation control unit 100 is provided for every two, or every four, or every eight columns. And the compensation control unit 100 may also be provided only in part of the pixel units 20 in the same column. The present disclosure makes no limitation thereto.

The First Embodiment and the Second Embodiment described above provide descriptions with the compensation control unit 100 being provided in the peripheral area and the compensation control unit 100 being provided in the display area respectively as examples, other disposing manners will not be repeated here, but they all fall into the protection scope of the present disclosure.

An embodiment of the present disclosure provides a display device, comprising any of the array substrate as described above, which has the same structure and advantageous effect as the array substrates in the above embodiments. Since the structure and advantageous effect of the array substrate have already been described in detail in the preceding embodiments, no more details will not be repeated here.

In this embodiment of the present disclosure, the display device may include an organic light emitting diode display device, for instance, the display device may be any product or component having a display function, like a digital photo frame, a mobile phone, or a tablet computer.

FIG. 6 is a flowchart of a driving method for an array substrate provided by an embodiment of the present disclosure. As shown in FIG. 6, the method may comprise the following steps.

S101: inputting, by a scan driving unit 10, an enable signal to one terminal of at least one driving control line Vdd in a display area (AA area), the enable signal being configured to drive the OLED device to emit light;

S102: controlling, by a compensation control unit 100, a compensation voltage source 101 to input a compensation voltage Vc to the other terminal of the driving control line Vdd; the compensation voltage Vc being less than or equal to a voltage (VDD) of the enable signal.

An embodiment of the present disclosure provides a driving method for an array substrate, comprising: inputting, by a scan driving unit 10, an enable signal to one terminal of at least one driving control line in a display area, the enable signal being configured to drive the OLED device to emit light; then controlling, by a compensation control unit, a compensation voltage source to input a compensation voltage to the other terminal of the driving control line. As such, in the light emitting phase, the compensation control unit can control the compensation voltage source to input the compensation voltage to the other terminal of the driving control line, thus compensating for the enable signal received by a pixel unit that is away from the scan driving unit. Since the compensation voltage is less than or equal to a voltage of the enable signal, mura caused by a constant decrease of the voltage of the enable signal during transmission (i.e., IR Drop) can be avoided. Thereby, quality of displayed pictures and quality of the display can be improved.

In order to reduce or avoid affects of the threshold voltage Vth on the current flowing through the OLED device, which may downgrade display quality, generally, a compensation loop is provided in the pixel circuit to compensate for the aforesaid threshold voltage Vth. During operation of a pixel circuit provided with a compensation circuit, it is possible to input an enable signal to the driving control line Vdd only in the light-emitting phase (a voltage of the enable signal is at a high voltage level), and input a low voltage level to the driving control line Vdd in the other phases such as the compensation phase. Thus, the voltage inputted to the driving control line is an AC voltage. As such, the compensation control unit 100 only needs to control the compensation voltage source 101 to input the compensation voltage Vc to the other terminal of the driving control line Vdd when the driving control line Vdd receives the enable signal (i.e., when a high voltage level is inputted to the driving control line Vdd).

Next, the above driving method will be illustrated in a case where AC voltage is inputted to the driving control line Vdd.

### Third Embodiment

For instance, description is provided with referring to FIG. 4 as an example. In a case where the compensation control unit 100 comprises at least one control switch 110, after the above step S101, the driving method may also include:

turning on the control switch 110, to connect the compensation voltage source 101 and the other terminal of the driving control line Vdd, so that the compensation voltage is inputted to the other terminal of the driving control line, thus compensating for the enable signal received by the pixel unit away from the scan driving unit, to avoid mura caused by a constant decrease of the voltage of the enable signal during transmission (i.e., IR Drop).

### Fourth Embodiment

For instance, description is provided referring to FIG. 5a or FIG. 5b as an example. In a case where the control switch 110 includes a thin film transistor 120, after the above step S101, the method may further comprise:

inputting the enable signal to a gate of the thin film transistor 120 to turn on the thin film transistor. The compensation voltage Vc inputted by the compensation voltage source 101 is input into the other terminal of the driving control line Vdd through the thin film transistor 120. Therefore, it compensates for the enable signal received by the pixel unit away from the scan driving unit, to avoid mura caused by a constant decrease of the voltage of the enable signal during transmission (i.e., IR Drop).

In comparison to the Third Embodiment, the Fourth Embodiment can control the compensation voltage source 101 to automatically input the compensation voltage Vc to the other terminal of the driving control line Vdd when the driving control line Vdd receives the enable signal.

As will be appreciated by those of ordinary skill in the art: all or part of the steps of the above method embodiments may be completed by instructing relevant hardware through programs, these programs may be stored in a computer readable storage medium, the steps included in the above method embodiments will be executed when the programs are executed; the aforesaid storage medium includes various media capable of storing program codes such as a ROM, a RAM, a magnetic disk, or an optical disk.

The above described are merely specific implementations of the present disclosure, however, the protection scope of the present disclosure is not limited thereto, modifications or replacements that are easily conceivable for those skilled in the art within the technique range disclosed in the present disclosure should all fall into the protection scope of the present disclosure. Therefore, the protection scope of the present disclosure should be based on what is claimed in the claims.

The present disclosure claims the priority of Chinese Patent Application No. 201410597271.X filed on Oct. 30, 2014, entire content of which is incorporated as part of the present invention by reference.

1. An array substrate, comprising:
a scan driving unit located in a peripheral area and configured to input an enable signal to one terminal of at least one driving control line in a display area; and further,
at least one compensation control unit and a compensation voltage source configured to provide a compensation voltage; wherein
one terminal of the compensation control unit is connected to the compensation voltage source, the other terminal thereof is connected to the other terminal of the at least one driving control line, and the compensation control unit is configured to control the compensation voltage source to input the compensation voltage to the other terminal of the driving control line;
wherein the compensation voltage is less than or equal to a voltage of the enable signal.

2. The array substrate as claimed in claim 1, wherein the compensation control unit includes at least one control switch;
one terminal of the control switch is connected to the compensation voltage source, and the other terminal thereof is connected to the other terminal of one of the driving control lines.

3. The array substrate as claimed in claim 2, wherein the control switch includes a thin film transistor;
a gate and a first electrode of each thin film transistor are connected to the other terminal of one of the driving control lines, and a second electrode thereof is connected to the compensation voltage source.

4. The array substrate as claimed in claim 3, wherein in a case where the compensation control unit is located in the peripheral area, the gate and the first electrode of the thin film transistor are connected to one terminal of the driving control line that is away from the scan driving unit.

5. The array substrate as claimed in claim 3, wherein in a case where the compensation control unit is located in the display area, one said thin film transistor is provided in one pixel unit of the display area.

6. The array substrate as claimed in claim 1, wherein the compensation voltage source is provided in the scan driving unit.

7. A display device, comprising the array substrate as claimed in claim 1.

8. A driving method for an array substrate, comprising:
inputting, by a scan driving unit, an enable signal to one terminal of at least one driving control line in a display area;
controlling, by a compensation control unit, a compensation voltage source to input a compensation voltage to the other terminal of the driving control line;
wherein the compensation voltage is less than or equal to a voltage of the enable signal.

9. The driving method for an array substrate as claimed in claim 8, wherein in a case where the compensation control unit includes at least one control switch, after inputting, by a scan driving unit, an enable signal to one terminal of at least one driving control line in a display area, the method further comprises:
turning on the control switch, to connect the compensation voltage source and the other terminal of the driving control line.

10. The driving method for an array substrate as claimed in claim 9, wherein in a case where the control switch includes a thin film transistor, after inputting, by a scan driving unit, an enable signal to one terminal of at least one driving control line in a display area, the method further comprises:
inputting the enable signal to a gate of the thin film transistor to turn on the thin film transistor;
inputting the compensation voltage inputted by the compensation voltage source to the other terminal of the driving control line through the thin film transistor.

11. The display device as claimed in claim 7, wherein the compensation control unit includes at least one control switch;
one terminal of the control switch is connected to the compensation voltage source, and the other terminal thereof is connected to the other terminal of one of the driving control lines.

12. The display device as claimed in claim 11, wherein the control switch includes a thin film transistor;
a gate and a first electrode of each thin film transistor are connected to the other terminal of one of the driving control lines, and a second electrode thereof is connected to the compensation voltage source.

13. The display device as claimed in claim 12, wherein in a case where the compensation control unit is located in the peripheral area, the gate and the first electrode of the thin film transistor are connected to one terminal of the driving control line that is away from the scan driving unit.

14. The display device as claimed in claim 12, wherein in a case where the compensation control unit is located in the display area, one said thin film transistor is provided in one pixel unit of the display area.

15. The display device as claimed in claim 7, wherein the compensation voltage source is provided in the scan driving unit.
